(19) United States
(12) Patent Application Publication
(10) Pub. No.: US 2012/0300649 A1
(43) Pub. Date: Nov. 29, 2012

(54) Mobile device throughput testing

(75) Inventors: Ramesh Parmar, Scotch Plains, NJ (US); Deepak Gonsalves, Avenel, NJ (US); Dinesh Doshi, South Plainfield, NJ (US); Deepa Jagannetha, Somerset, NJ (US)

(73) Assignee: w2bi, Inc.

(21) Appl. No.: 13/452,374

(22) Filed: Apr. 20, 2012

Related U.S. Application Data
(63) Continuation-in-part of application No. 12/123,823, filed on May 20, 2008, now abandoned.
(60) Provisional application No. 60/939,258, filed on May 21, 2007.

(51) Int. Cl. H04W 24/00

(52) U.S. Cl. 370/252

(57) ABSTRACT

The instant invention is a program applet that can be loaded onto mobile devices and directly interfaces with the operating system and automated test scripts. The program applet is capable of initiating the required transfer and will provide information regarding the progress of the transfer such that a test client can properly calculate the data throughput rates. The result is a minimization of time-to-market for test and measurement tools using software architecture that simplify and speed-up development and maintenance of test and measurement tools by removing awareness of complexity of external hardware dependencies from the actual test and measurement software code, and placing dependencies management to carefully defined components that could be reused and shared between multiple test and measurement software tools and systems at once.

### CROSS-REFERENCE TO RELATED APPLICATIONS

This application is a continuation-in-part of U.S. patent application Ser. No. 12/123,823, filed on May 20, 2008, which claims priority of U.S. Provisional Application 60/939,258, filed May 21, 2007. The contents of all of the aforementioned applications are herein incorporated by reference.

### BACKGROUND OF THE INVENTION

Carriers/OEMs are often concerned about measuring the maximum data throughput on a mobile device in bits per second of a communications link or network access. Conceptually the Mobile Devices can be seen as being two areas that work in tandem. The OS controls the main interface to the user, as well as multimedia applications that are residing on the device. The OS can be any standard OS but not limited to Windows, Palm, Linux, Symbian, Android, iOS, Windows Mobile, Windows Phone, etc. The applications residing on the phone are agnostic to the underlying wireless technology to carry radio packets over-the-air.

In computer networks, ‘goodput’ is the application level throughput, i.e. the number of useful information bits, delivered by the network to a certain destination, per unit of time. The amount of data considered excludes protocol overhead bits as well as retransmitted data packets. This is related to the amount of time from the first bit of the first packet is sent (or delivered) until the last bit of the last packet is delivered, see below.

A typical method of performing a measurement is to transfer a ‘large’ file from one system to another system and measure the time required to complete the transfer or copy of the file, if reliable (based on TCP) transfer protocol is in use. If unreliable (based on UDP) transfer protocol is in use, then total data sent and received are being measured for throughput calculations. The throughput is then calculated by dividing the size of transferred data by the time of transfer in gigabits, megabits, kilobits, or bits per second. Unfortunately, the results of such an exercise will result in the goodput rate which is typically less than the maximum theoretical data throughput, leading to the belief that their communications link is not operating correctly. In fact, there are many transmission overheads, including latency, TCP Receive Window size and system limitations, which means the calculated goodput does not reflect the maximum achievable throughput.

Traditionally these tests are manually performed due to fast pace software changes and the rate mobile applications are being introduced. Simulating different radio and IP network conditions concurrently while performing application specific actions is complex and requires coordination and synchronization of systems through a central system.

The ability to transfer data and access web pages is a standard features for wireless devices. As such there is need to measure performance and determine if a device meets stated requirements.

Wireless devices can be used in one of the two modes for data transfer and web access. In a tethered mode, the wireless device is attached to a PC and is used as a modem. The device provides connectivity, but the data transfer is done between the network server and an application on the PC. This mode of connectivity is used with traditional cell phones.

In a non tethered mode, the device is not attached to a PC; the device itself is capable of initiating a FTP or HTTP transfer. This mode is more frequently used with smart phones that have a WINDOWS, PALM, Symbian, Blackberry etc., based operating system. In these devices, the UI on the device allows the user to initiate either the file transfer or the web access.

Non-tethered testing mode requires a native FTP and HTTP agent on the device which can be controlled programmatically via test scripts which reside on a test controller PC.

Automated testing of wireless mobile devices for data functionality and performance require the ability to transfer files and web pages via FTP and HTTP protocols respectively. When the testing utilizes the mobile device as a modem, a test agent on the PC can be used to automate this process.

A problem uncovered is the inability to provide accurate mobile device measurement which assimilates operational characteristics likely to be encountered under normal and heavy consumer use.

Thus, what is needed in the art is a means for measuring the performance of a mobile device that assimilates actual consumer conditions. The current invention accomplishes data throughput performance testing through a centralized system in a simulated environment. The core of invention is the architecture provided by wireless system simulator component and data performance testing component.

### SUMMARY OF THE INVENTION

Disclosed is a method of testing data throughput performance testing through a centralized system in a simulated environment. The method enables test executive software to run the same test and measurement code without introducing dependencies to hardware network emulators. Software allows for test and measurement procedures by executing specialty test and measurement software code, perform data performance assessment in simulated wireless network conditions and collect test results data. Additional sequences of application actions can be applied and modification of network conditions across multiple hardware network emulators synchronously is employed. Test automation allows repeatable test sequence (built from random track), allowing for a random process to simulate end user events, record these events, and create a test sequence that can be repeated across the same device many times, or many devices. The current invention accomplishes data throughput performance testing through a centralized system in a simulated environment. Architecture provided by a wireless system simulator component and data performance testing component enables the test executive software to run exactly same test and measurement code without introducing dependencies to hardware network emulator implementation.

An objective of the program applet is to assimilate: Initiation and Termination of data call; FTP Upload; FTP Download; FTP Bi-directional File transfer; HTTP Upload; HTTP Download; HTTP Bi-directional File transfer; HTTP Download (Web Access); Screen Capture; Key Press and other features that may be particular to the mobile device.

Another objective of the invention is to create an applet that can be loaded onto the mobile devices and directly interface with the operating system and automated test scripts.

Still another objective of the program applet of the instant invention is act an applet on a test device wherein automated scripts will control the program applet applet and initiate the required data transfer.

Yet still another objective of the instant invention is for use of a program applet to obtain information regarding the progress of data transfer such that the test device can properly calculate the data throughput rates.

Another objective of the instant invention is to provide a program applet that behaves as a client server application, allows the user to connect to the device, remotely invoke API commands and examine the information returned from the device.

Still another objective of the program applet is to cause operation of the program as either background application or a service.

Yet still another objective of the instant invention is for use of a program applet having a small memory footprint so as not to impact the operation of the device.

Still another objective of the instant invention is for use of a program applet that works with all phones including Windows, PALM, Symbian, Linux and so forth.

Another objective of the instant invention is for use of a program applet that is agnostic to the wireless cellular technology and works through the OS APIs, thus allows working on both CDMA and GSM based phones.

These and other objectives and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE DRAWINGS

FIG. 1 is a flow diagram depicting the interface between a desktop module and a device module;

FIG. 2 is a flow diagram illustrating an infrared connection;

FIG. 3 is a flow diagram depicting a flow diagram of a mobile device data throughput testing using a program applet;

FIG. 4 is a flow diagram of System Components;

FIG. 5 is a measure throughput performance on a mobile device.

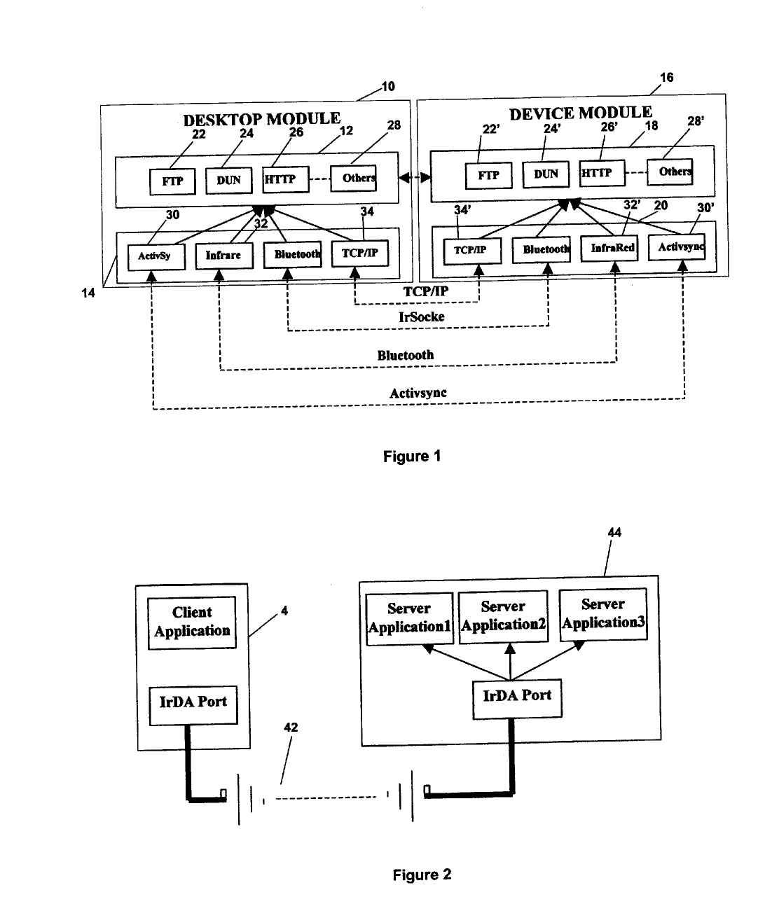

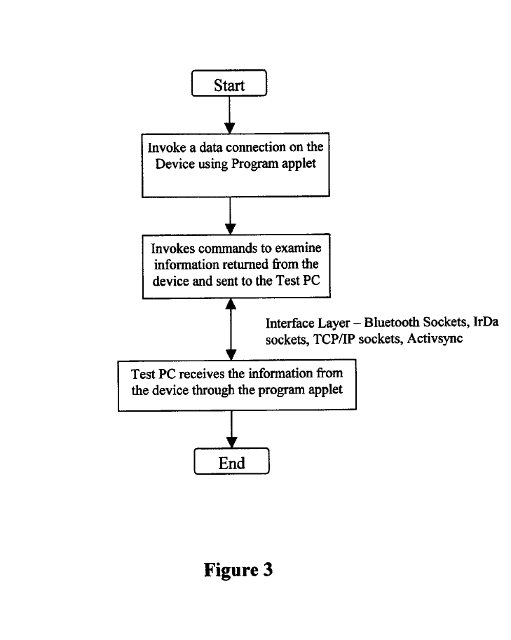

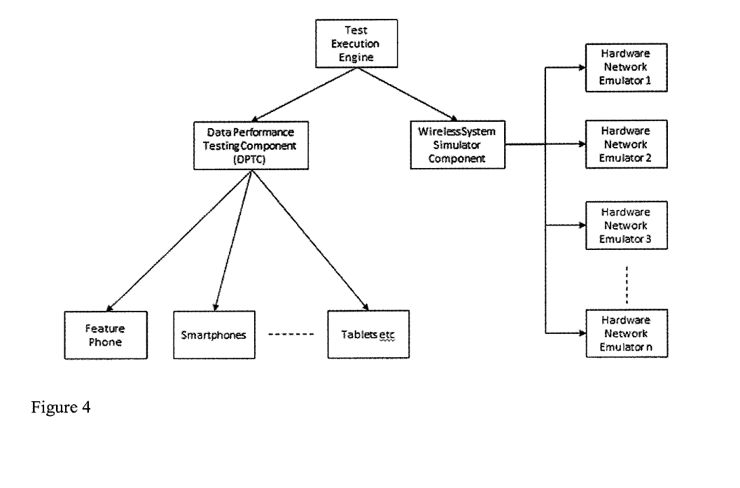

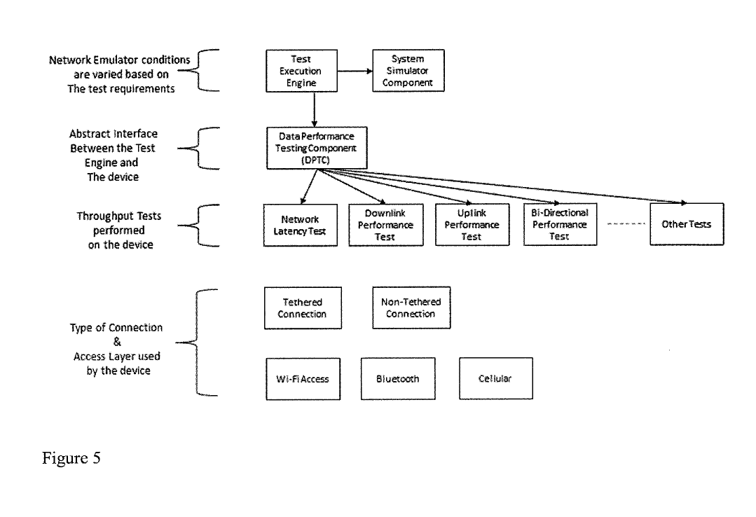

### DETAILED DESCRIPTION OF THE PREFERRED EMBODIMENT

Referring now to the Figures, the core of invention is the architecture that defines abstract unified programming interfaces provided by wireless system simulator component and data performance testing component. This enables the test executive software to run exactly same test and measurement code without introducing dependencies to hardware network emulator implementation. This also keeps the test and measurement code unaware of the actual unit under test implementation and/or physical disposition.

Test executive engine always uses same control channel and protocol to communicate with single wireless system simulator component and leaves translation and actual control channel implementation up to a hardware network emulator component under consideration. If the unit under test is either a module that is embedded to a test executive PC or a module that is tethered to a test executive PC (in both cases dial-up, or network, or Wi-Fi/Wi-Max connection that corresponds to an unit under test is present on a test executive PC), then data performance testing component executes test code for data performance assessment on the test executive PC itself.

If the unit under test does not provide any sort of connection for a test executive PC and is capable of executing test code for data performance assessment on its own and report test and measurement results back to a test executive PC (smart device), then exactly same test code for data performance assessment that is usually being executed by a test executive PC, will be compiled for a software platform specific for a smart device under test in a form of test agent, and data performance testing component will be programmatically reconfigured to only control and poll test agent running on a smart device for current data performance assessment measurement data and final data performance assessment results.

The Test Execution engine provides the framework to select various network conditions to measure the performance of the device under different wireless conditions (unimpaired radio channel, moving pedestrian, vehicle or high-speed train, etc.).

The input data is relayed to the Wireless System Simulator and the Data Performance Testing Component: Wireless System Simulator will translate test conditions requested by the Test Execution Engine to concrete values that are understood by the underlying hardware wireless network simulator (one or multiple, depending on the wireless conditions required by the scenario), using communication protocol and control channel specific to the hardware wireless network simulator. DTPC will choose the actual test functionality implementation based on the type of device in use, control channel and protocol.

DTPC initiates a connection with the device to perform tests as required by Test Execution Engine:

a. Network latency test—unit under test is used to ping remote host and measure round-trip time for latency assessment.
b. Downlink performance test—unit under test is used to either download a file (if TCP-based protocol is being assessed) or receive continuous UDP payload (if UDP-based protocol is being assessed), time to transfer data is being recorded and downlink throughput is being calculated.
c. Uplink performance test—unit under test is used to either upload a file (if TCP-based protocol is being assessed) or send continuous UDP payload (if UDP-based protocol is being assessed), time to transfer data is being recorded and uplink throughput is being calculated.
d. Bi-directional performance test—unit under test is used to download and upload files simultaneously (if TCP-based protocol is being assessed) or receive and send continuous UDP payload simultaneously (if UDP-based protocol is being assessed), time for transferring data in both directions is being recorded and throughput is being calculated per direction. If either of the directions finishes earlier, measurements stop and throughput calculation is being performed.

Depending on the actual unit under test, tests described above are being executed either by DTPC directly on the PC where Test Execution Engine resides, or instructions to start/stop test and collect immediate/final test results are being relayed to the Test Agent that is executed on the unit under test, using control channel and protocol defined by the described architecture.

Test Execution Engine constantly polls DTPC for immediate throughput data in order to provide user feedback. After DTPC finishes data transfer, final result is being collected by the Test Execution Engine and test results assessment is being performed, producing the verdict of whether the unit under test performs according to the test expectations.

The overall architecture of the test environment with the incorporation of the program applet of the instant invention is depicted by a desktop module 10 with an Application Layer 12 shown as Dial-Up Networking, FTP, HTTP, Others and a Transport Medium Layer 14 shown as Activsync, InfraRed, Bluetooth, TCP/IP adaptors. Similarily, the device module 16 has an Application Layer 18 shown as Dial-Up Networking, FTP, HTTP, Others and a Transport Medium Layer 20 shown as Activsync, InfraRed, Bluetooth, TCP/IP adaptors.

The Application layer File Transfer Protocol (FTP) 22 & 22′ is software that is designed to transfer files back-and-forth between two computers over the Internet. FTP is a protocol used for exchanging files over any TCP/IP based network to manipulate files on another computer on that network regardless of which operating systems are involved (if the computers permit FTP access).

The Application layer Dial-up Networking (DUN) 24 & 24′ is a feature that enables a Mobile Device to function as a wireless modem. DUN profile provides a standard to access the Internet and other dial-up services. The most common scenario is accessing the Internet from a laptop by using mobile device as modem.

Hypertext Transfer Protocol (HTTP) 26 & 26′ is a request/response standard between a client and a server. Typically, an HTTP client initiates a request. It establishes a Transmission Control Protocol (TCP) connection to a particular port on a host (port 80 by default; see List of TCP and UDP port numbers). An HTTP server listening on that port waits for the client to send a request message. Upon receiving the request, the server sends back a status line, such as “HTTP/1.1 200 OK”, and a message of its own, the body of which is perhaps the requested file, an error message, or some other information.

Others 28 & 28′ include Key press and Image Capture functionality—Every Key press on the device is controlled by the program applet and provides a full control for executing Automation Scripts. It also has inbuilt functions to take snapshots on the device screen and send it to the Test PC in a bitmap or jpeg format.

The Transport Medium Layer includes an ActivSync Adaptor 30 & 30′ which acts as the gateway between a Windows-based PC and Windows Mobile-based device, enabling the transfer of Outlook information, Office documents, pictures, music, videos and applications to and from the device. This Adaptor on the PC communicates with the Activsync Adaptor on the MOBILE DEVICES using RAPI calls.

The Infrared Adaptor 32 & 32′ IrDA standard contains all fundamental specifications for wireless data communication via infrared. Thus the greatest possible compatibility between devices of different manufacturers can be reached. The IrDA has published a set of standards that define the physical and software-specific layers necessary for smooth communication between two infrared devices. The Test PC and Mobile device uses the Infrared sockets to invoke the RAPI calls which will be used for mutual communication, execution of specific commands for automating the device.

With the implementation of the infrared connection it is enough to know the following: each IrDA server application 40 that maintains the infrared connection 42 enables such an LSAP selector and a service name. Each Client application uses this kind of the addressing to build up a connection to the server application 44. All well-known Socket functions (like “send” or “recv”) can be used in their usual way accordingly to these restrictions and changes. The LSAP selector can be compared with a port number under TCP/IP and corresponds to a number between 0 and 127. If one wants to address the IrDA equipment, he can select either a desired LSAP Selector or indicate a service name, whereby a free LSAP Selector is selected automatically.

The Transmission Control Protocol (TCP) is one of the core protocols of the Internet protocol suite. TCP provides reliable, in-order delivery of a stream of bytes, making it suitable for applications like file transfer and e-mail. It is so important in the Internet protocol suite that sometimes the entire suite is referred to as “the TCP/IP protocol suite.” TCP is the transport protocol that manages the individual conversations between web servers and web clients. TCP divides the HTTP messages into smaller pieces, called segments, to be sent to the destination client. It is also responsible for controlling the size and rate at which messages are exchanged between the server and the client. The Test PC and Mobile device uses the TCP/IP sockets 34 & 34′ to invoke the RAPI calls which will be used for mutual communication, execution of specific commands for automating the device TCP uses the notion of port numbers to identify sending and receiving application end-points on a host, or Internet sockets. Each side of a TCP connection has an associated 16-bit unsigned port number (1-65535) reserved by the sending or receiving application. Arriving TCP data packets are identified as belonging to a specific TCP connection by its sockets, that is, the combination of source host address, source port, destination host address, and destination port. This means that a server computer can provide several clients with several services simultaneously, as long as a client takes care of initiating any simultaneous connections to one destination port from different source ports.

Remote API (RAPI) is a remote procedure call (RPC) that enables communication between two applications. The prototypes that are defined in the Rapi.h file enable desktop computer applications to remotely manage devices. RAPI communicates requests from a desktop computer application to invoke a function and returns the results of that function. The exported functions relate to the registry, file system, and databases, in addition to functions for querying the system configuration. Although most RAPI functions are duplicates of functions in the Microsoft® Windows® CE API, a few new functions extend the API.

The Mobile Devices can be seen as being two areas that work in tandem. The OS controls the main interface to the user as well as application such as the phonebook, SMS, MMS, camera, etc. The OS can be any standard OS but not limited to Windows, Palm, Linux, Symbian, etc. The phone system is responsible for managing call processing. The phone system can be based on any mobile technology such as but not limited to CDMA, TDMA, GSM, WCDMA, EDGE, GPRS, EVDO, etc. In the remainder of the document, Windows and CDMA will be used as generic terms for the OS and cellular technology respectively.

When testing data throughput on Mobile Devices like smart phones, the phone is connected to a PC based test client which has a FTP and HTTP file transfer client program. During the testing, the PC client establishes a data call through the mobile device which acts as a modem. Once the data connection is established the required file transfer or HTTP page download is executed. The test client monitors the first and last data packet as well as the elapsed time. This allows the calculation of data throughput rates.

When operating in the non-tethered mode, the data connection is created directly from the device. Once the connection is established, the data application can ride on top of the data connection.

A proposed solution to this issue is to create the program applet that can be loaded onto the mobile devices and directly interface with the operating system and automated test scripts. The program applet will act as an Applet on the test device. The automated scripts will control the applet and initiate the required data transfer. The applet will provide information regarding the progress of the transfer such that the test client can properly calculate the data throughput rates.

The program is an applet on the mobile device which can be controlled by the automated test scripts. To complete the automated test scenario, a “glue” layer is needed to allow the test scripts to interface with the program applet API. This glue layer also includes a transport mechanism which can be, but not limited to ActivSync, Bluetooth, IR, Wireless (WiFi or WiMax) etc.

The program applet behaves as a client server application. It allows the user to connect to the device, remotely invoke API commands and examine the information returned from the device.

The program applet allows the user to initiate a file transfer in either FTP or HTTP protocol. The allowable transfers should be upload, download and bi-directional.

The API in the program applet allows test scripts running on a test PC to control file transfers and HTTP webpage access.

During the execution of automated scripts, the scripts invoke the program applet via the interface layer which resides on the test PC. The interface layer and program applet are responsible for establishing and maintaining communications. The communication between the script and the program applet support bi-directional communications allowing the script to make calls to the program applet API via the interface layer and obtain the return values. Communications from the script through the interface is supported by different physical layer based connections such as USB or serial communications for hardwired connects and via IR or Bluetooth for wireless communications. The protocol used for communications should similar to ActivSync.

The program applet captures the snapshot of the device and sends it to the Test PC. Every Key press on the device is controlled by the program applet and provides a full control for executing Automation Scripts: supports “Key tap”; supports “Dial Number”; supports “Answer Call”; supports “End Call”; Supports Navigation such as “Open Message & Close Message”. The program applet starts automatically when the device is power cycled. It also re-establishes communications with the interface layer. The program applet has functions on the client and server to support key taps and display captures.

KEY TAPS—During execution of automated scripts, simulating key taps on the smart device without user intervention is a big task. The program applet has built-in functions which uses the following methods for the key tap simulation: Virtual Key Code mapping to simulate the Key Tap functionality; and taking the coordinates on the screen before configuring and simulating them at a later stage.

DISPLAY CAPTURE—The program applet has built-in functions to take snapshots on the device screen and send it to the Test PC in a bitmap or jpeg format.

The following Instruction commands are implemented in the program applet applet. These actions can be accessed by test scripts or test clients. Unless otherwise noted, the function is applicable to both FTP and HTTP:

InitializeTransferProtocols: Provides instructions to initialize Data Transfer Protocols.
DoTransfer: Provides instructions to start Data Transfer on the device.
DoPing: Instructions to PING the device.
GetTransferStatistics: Provides instructions to get the data transfer statistics from the device.
Upload Statistics:
   Number of bytes transferred;
   Number of bytes already transferred;
   Number of bytes still to transfer;
   Elapsed Time;
   Throughput value.
Download Statistics:
   Number of bytes to transfer;
   Number of bytes already transferred;
   Number of bytes still to transfer;
   Elapsed time;
   Throughput value.
      IsExceptionAvailable: Provides instructions for exception handling:
Upload or download exception errors;
Any return time values that provides either an absolute time or an elapsed time should be in milliseconds.
   TerminateApplication: Provides instructions for terminating the “program applet” application.
   CloseTransferProtocols: Provides instructions to close the Data Transfer Protocols.
   EnumerateDataConnections: Provides instructions to get the count of Data connections.
   InitiateDataCall: Provides instructions to initiate a Data Call.

TerminateDataCall: Provides instructions to terminate a Data Call.

Detailed embodiments of the instant invention are disclosed herein, however, it is to be understood that the disclosed embodiments are merely exemplary of the invention, which may be embodied in various forms. Therefore, specific functional and structural details disclosed herein are not to be interpreted as limiting, but merely as a basis for the claims and as a representation basis for teaching one skilled in the art to variously employ the present invention in virtually any appropriately detailed structure.

All patents and publications mentioned in this specification are indicative of the levels of those skilled in the art to which the invention pertains. All patents and publications are herein incorporated by reference to the same extent as if each individual publication was specifically and individually indicated to be incorporated by reference. It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the stated claims or objectives.

What is claimed is:

1. A method of testing data throughput rate on a mobile device comprising the steps of:
coupling said mobile device to a network emulator having test executive code, said network emulator capable of electronic file transfer;
establishing a data transfer connect between said network emulator and said mobile device;
loading a program applet having application actions including automated test scripts capable of simulating key tap functionality by way of virtual key code mapping onto said mobile device, said program applet controlled by automated test scripts capable of data packet transfer;
originating a data call through said mobile device and said network emulator;
initiating a data transfer between said network emulator and said mobile device;
applying a sequence of application actions and modifying network conditions across multiple network emulators synchronously;
determining an elapsed time of data transfer;
wherein said applet calculates the elapsed time of file transfer and throughput rate forming a repeatable test sequence to simulate end user events for transfer and recordation by said network emulator.

2. The method of testing data throughput rate on a mobile device according to claim 1 wherein said automated test scripts includes a transport mechanism for coupling selected from the group of: ActivSync, Bluetooth, Infrared, WiFi, or WiMax.

3. The method of testing data throughput rate on a mobile device according to claim 1 wherein the test scripts use single control connection over TCP/IP to configure a wireless system simulator component to desired wireless network conditions and collect test result data.

4. The method of testing data throughput rate on a mobile device according to claim 1 wherein said network emulator uses TCP/IP, serial port or GPIB connection to translate requested conditions and test result data to and from the network emulator employed.

5. The method of testing data throughput rate on a mobile device according to claim 1 wherein said applet operates as a client server application to remotely invoke API commands and examine the information returned from the device.

6. The method of testing data throughput rate on a mobile device according to claim 1 wherein electronic file transfer can be uploaded, downloaded and bi-directional.

7. The method of testing data throughput rate on a mobile device according to claim 1 wherein said network emulator is a test executive PC.

8. The method of testing data throughput rate on a mobile device according to claim 1 wherein said program applet instructs test scripts running on a test executive PC by use of an interface layer residing on the test executive PC to control file transfers and HTTP webpage access.

9. The method of testing data throughput rate on a mobile device according to claim 1 wherein input data is relayed to a wireless system simulator and a data performance testing component, said wireless system simulator translates test conditions requested by the test execution engine into values understood by said network emulator.

10. The method of testing data throughput rate on a mobile device according to claim 9 wherein said data performance testing component chooses test functionality based on the type of mobile device in use, control channel and protocol.

11. The method of testing data throughput rate on a mobile device according to claim 1 wherein said test is for network latency whereby the mobile device pings a remote host and measures trip time for latency assessment.

12. The method of testing data throughput rate on a mobile device according to claim 1 wherein said test is for downlink performance test whereby the mobile device is used to upload a file to assess TCP-based protocol and measure time of data transfer.

13. The method of testing data throughput rate on a mobile device according to claim 1 wherein said test is for UDP protocol whereby the mobile device is used to send continuous UDP payload and measure time of data transfer.

14. The method of testing data throughput rate on a mobile device according to claim 1 wherein said test is a bi-directional performance test wherein files are downloaded and uploaded simultaneously if TCP-based protocol is being assessed and time for transferring data in both directions is recorded and throughput calculated per direction.

15. The method of testing data throughput rate on a mobile device according to claim 1 wherein said test is a bi-directional performance test wherein UDP payload files are received or sent simultaneously if UDP based protocol is being assessed and time for transferring data in both directions is recorded and throughput calculated per direction.

16. The method of testing data throughput rate on a mobile device according to claim 1 wherein said test is executed by DTPC directly on the network emulator.

17. The method of testing data throughput rate on a mobile device according to claim 1 wherein instructions to start/stop test and collect immediate/final test results are being relayed to a Test Agent that is executed on the mobile device under test.

18. The method of testing data throughput rate on a mobile device according to claim 1 wherein said program applet further comprising the steps of:
initializing Data Transfer Protocols and starting of instructions to start Data Transfer on the mobile device;
providing instructions to PING the mobile device; and
uploading or downloading of data transfer statistics from the mobile device.

19. The method of testing data throughput rate on a mobile device according to claim 18 wherein said uploading of data transfer includes:
recording the number of bytes transferred;
determining the number of bytes already transferred;
calculating the number of bytes still to transfer;
registering of the elapsed Time; and
calculating the throughput value.

20. The method of testing data throughput rate according to claim 18 wherein said downloading of data transfer includes:
recording the number of bytes transferred;
determining the number of bytes already transferred;
calculating the number of bytes still to transfer;
registering of the elapsed Time; and
calculating the throughput value.
